(19) United States
(12) Patent Application Publication
(10) Pub. No.: US 2008/0019626 A1
(43) Pub. Date: Jan. 24, 2008

(54) CONNECTING ROD BEARING SHELL OR BUSH OR MAIN BEARING SHELL FOR COMBUSION ENGINES

(75) Inventors: Werner Schubert, Wiesloch (DE); Klaus Deicke, Untereisesheim (DE); Wolfgang Bickle, Reilingen (DE); Friedhelm Gerlach, Westoverledingen (DE)

Correspondence Address: BRINKS HOFER GILSON & LIONE, P.O. BOX 10395, CHICAGO, IL, 60610, US

(73) Assignee: KS Gleitlager GmbH, St. Leon-Rot (DE)

(21) Appl. No.: 11/834,479

(22) Filed: Aug. 6, 2007

Related U.S. Application Data
(63) Continuation of application No. PCT/EP06/00758, filed on Jan. 28, 2006.

(30) Foreign Application Priority Data
Feb. 4, 2005 (DE) 10 2005 006 719.0

(51) Int. Cl. F16C 35/00

(52) U.S. Cl. 384/430

(57) ABSTRACT

The invention relates to a connecting rod bearing shell or bush for combustion engines or a main bearing shell for mounting the crankshaft of combustion engines. Said bearing shell or bush is made of a composite plain bearing material comprising a metallic, especially steel support layer, a metallic sliding layer (2) that is applied thereto and is formed from a copper-zinc alloy containing 10 to 25 percent by weight of Zn and 1 to 8 percent by weight of Ni, and a sputtered-on overlay layer (4) which faces the sliding layer, is made of an aluminum-tin alloy, and is sputtered directly onto the sliding layer such that a thin nickel barrier layer (10) having a thickness of less that 1 μm is formed.

### CROSS-REFERENCE TO RELATED APPLICATIONS

This application is a continuation of International Application No. PCT/EP2006/000758 filed on Jan. 28, 2006, which claims the benefit of German Application No. 10 2005 006 719.0, filed Feb. 4, 2005. The disclosures of the above applications are incorporated herein by reference.

### FIELD

The disclosure relates to materials for use in, by way of example, a connecting rod bearing shell or bush in combustion engines, or main bearing shell, for supporting the crankshaft in combustion engines.

### BACKGROUND

The statements in this section merely provide background information related to the present disclosure and may not constitute prior art.

The demands made of connecting rod bearing elements, namely of connecting rod bearing shells that surround the crank journals of a crankshaft, and connecting rod bearing bushes that can be press-fitted into the small connecting rod bearing, are manifold. On the one hand, for the connecting rod bearing shells resistance to even high sliding speeds and medium loads is demanded, on the other, in the case of connecting rod bearing bushes, resistance under high loads and comparatively high temperatures, but at low to moderate sliding speeds, is demanded. The demands made of main bearing shells for crankshafts are characterized by the lesser load that occurs, compared to connecting rod bearing shells, and the high sliding speed at relatively moderate temperatures. Furthermore, main bearing shells must be capable of compensating for errors of alignment of the crankshaft.

A generic connecting rod bearing shell or bush and a main bearing shell of the type defined at the outset are known from German Patent Disclosure DE 101 44 126 A of the present Applicant, the contents of which are incorporated by reference herein in their entirety, in which the nickel content of the sliding layer according to this reference amounts to only from 1 to 3 weight % nickel.

If the aforementioned sputtered-on overlay layer comprising an aluminum-tin alloy is intended to serve as a permanent running/sliding layer, then layer thicknesses of over 10 μm are selected; if it is meant to serve only as an initial temporary sliding layer (run-in layer), then layer thicknesses in the range from 2 to 6 μm are selected. It has thus been presumed so far that for the application of the overlay layer, but also for the sake of subsequent operation at relatively high temperatures, it was absolutely necessary before applying this layer by sputtering to embody a diffusion barrier layer, typically formed of nickel or nickel alloy, on the sliding layer. A diffusion barrier layer of this kind typically has a thickness of at least 1.5 μm, in particular at least 2.0 μm. It is intended to prevent the diffusion of the alloy components of the sliding layer into the overlay layer, but also to prevent the diffusion of the tin from the overlay layer into the sliding layer.

### SUMMARY

According to the present disclosure, an overlay layer applied by sputtering is sputtered directly onto the sliding layer, or in other words not onto a previously applied diffusion barrier layer; and that a thin nickel barrier layer is thereby formed that has a thickness of less than 1 μm. The nickel barrier layer has a thickness in particular of less than 0.9 μm, in particular less than 0.8 μm, in particular less than 0.7 μm, in particular less than 0.6 μm, and furthermore in particular less than 0.5 μm, but of at least 0.1 μm, in particular at least 0.2 μm.

With the present disclosure, it has been found that an overlay layer of the aforementioned type can be applied by sputtering onto the sliding layer even before prior application of a diffusion barrier layer, in particular a nickel barrier, and specifically without leading to unwanted diffusion processes and to the formation of a wide transition zone of undefined composition between the sliding layer and the overlay layer. Instead, it has surprisingly been found that when the aluminum-tin alloy is applied by sputtering onto the nickel-bearing sliding layer, a very thin nickel barrier layer with a thickness of <1 μm forms by itself. This nickel barrier layer then acts similarly to a thick diffusion barrier layer, which until now was separately applied, and prevents uncontrolled diffusion of the components of the sliding layer and the overlay layer.

It furthermore proves advantageous if the sliding layer has from 1 to 3 weight % manganese, which proves advantageous with a view to a finer particle size.

It also proves to be advantageous if the sliding layer has from 0.5 to 6 weight % iron, in particular from 1 to 4.5 weight % iron. Such a high iron content has a hardening effect and enhances the toughness of the material; it also makes for a finer particle size and increases the temperature of recrystallization of the alloy.

Adding from 1 to 3 weight % aluminum further increases the strength of the sliding layer alloy somewhat.

An advantageous composition of the sliding layer alloy is disclosed in claim 8.

A connecting rod bearing shell or bush or main bearing shell of the disclosure having a very thin diffusion barrier layer can accordingly be obtained by providing that the overlay layer comprising an aluminum-tin alloy is applied by sputtering directly onto the sliding layer without prior provision of a diffusion barrier layer.

Protection is also claimed for a method for producing a connecting rod bearing shell or bush or a main bearing shell of the type according to the disclosure, as defined by the characteristics of claims 10 and 11.

It will also be pointed out that the present disclosure is not limited solely to connecting rod bearing shells or bushes and main bearing shells in combustion engines; on the contrary, the disclosure encompasses slide bearing composite materials per se, with a steel support layer and a sliding layer with a preferably moderate zinc content of from 10 to 25 weight % and with from 1 to 8 weight % of nickel, with which contents it has been recognized according to the invention that by direct sputtering of an aluminum-tin alloy onto the preferably previously plasma-etched surface of the sliding layer, a very thin diffusion barrier layer can be formed.

Further details, characteristics and advantages of the invention will become apparent from the appended claims and from the ensuing description of the drawings and description of one form of the present disclosure.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

In order that the invention may be well understood, there will now be described an embodiment thereof, given by way of example, reference being made to the accompanying drawing, in which:

FIGS. 1a-1d show micrographs of a section perpendicular to the plane of a slide bearing composite material of a connecting rod bearing shell according to the disclosure (on the left) and a connecting rod bearing shell with an additional diffusion barrier layer, after application by sputtering and after 100 h, 200 h and 500 h (h hours) of artificial aging at 180° C.;

FIGS. 2a-2f show a micrograph and scanning electron microscope assays of the contents of Al, Zn, Cu, Sn, and Ni in a slide bearing composite material of a connecting rod bearing shell according to the disclosure, after the application of the overlay layer by sputtering:

FIGS. 3a-3f show a micrograph and scanning electron microscope assays as in FIGS. 2a-2f after 500 h of artificial aging at 180° C.;

FIGS. 4a-4f show a micrograph and scanning electron microscope assays of the contents of Al, Zn, Cu, Sn, and Ni in a slide bearing composite material of a connecting rod bearing shell, with a separately applied diffusion barrier layer, after the application of the overlay layer by sputtering; and

FIGS. 5a-5f each show a micrograph and assays as in FIGS. 4a-4f after 500 h of artificial aging at 180° C.

### DETAILED DESCRIPTION

The following description is merely exemplary in nature and is not intended to limit the present disclosure, application, or uses.

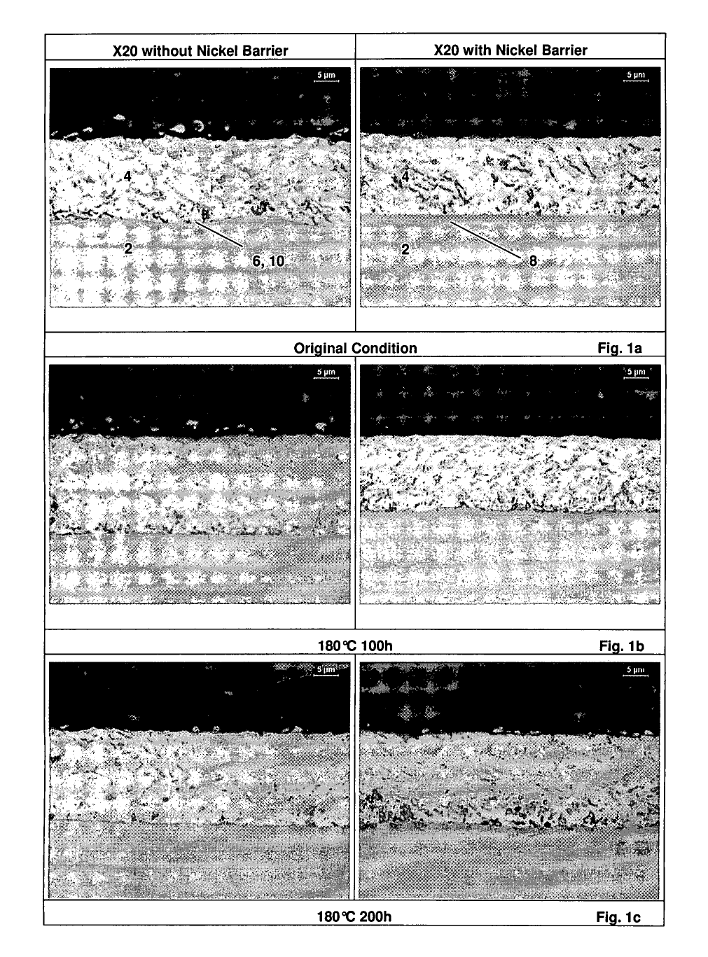

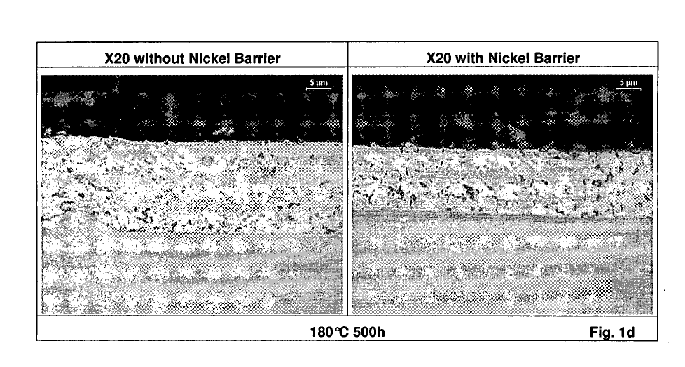

FIG. 1 a shows a micrograph of a section through a connecting rod bearing shell of the present disclosure having the composition CuZn(20,7)Mn(2,3)Ni(2,2)Fe(1,4)Al(2,2); in the drawings on the left, before the application by sputtering of an AlSn20 alloy as an overlay layer, no diffusion barrier layer was provided, and in the drawings on the right, a diffusion barrier layer in the form of a nickel barrier at least 2 μm thick has been applied. FIGS. 1b, 1c and 1d show corresponding micrographs, but after artificial aging of the applicable connecting rod bearing shell at 180° C., after 100 h (FIG. 1b), after 200 h (FIG. 1c), and after 500 h (FIG. 1d).

Reference numeral 2 designates the sliding layer, and reference numeral 4 designates the overlay layer applied by sputtering. From the micrographs made with an optical microscope, it can be seen that there is no alteration as a consequence of the artificial aging. However, a very thin transition layer 6 can be seen between the sliding layer 2 and the overlay layer 4 (on the left) and the very thick diffusion barrier layer 8, formed separately before the application by sputtering of the overlay layer 4 (on the right).

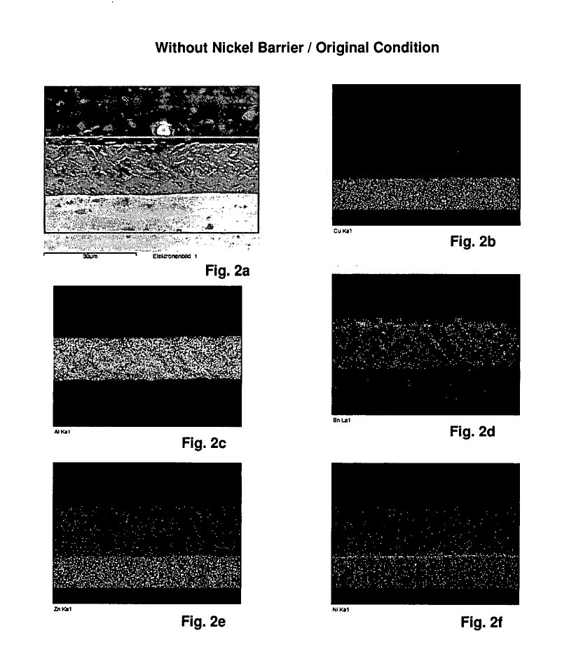

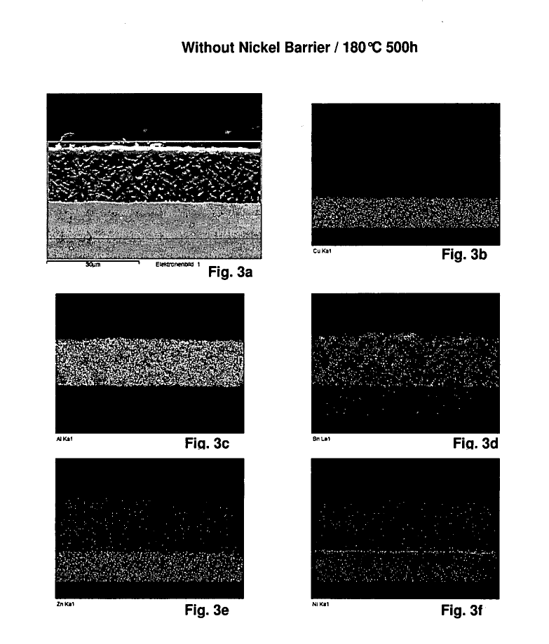

As found by scanning electron microscope assays of the layer construction of the connecting rod bearing shell of the invention as shown in FIGS. 2a through 2f (showing the condition immediately after the sputtering-on of the AlSn20 overlay layer) and FIGS. 3a through 3f (after artificial aging at 180° C., 500 h), the thin transition layer is a nickel layer, or in other words a nickel barrier layer 10 that already forms in the sputtering, and that, as the investigations in FIGS. 3a through 3f show, is stable even after 500 h of artificial aging.

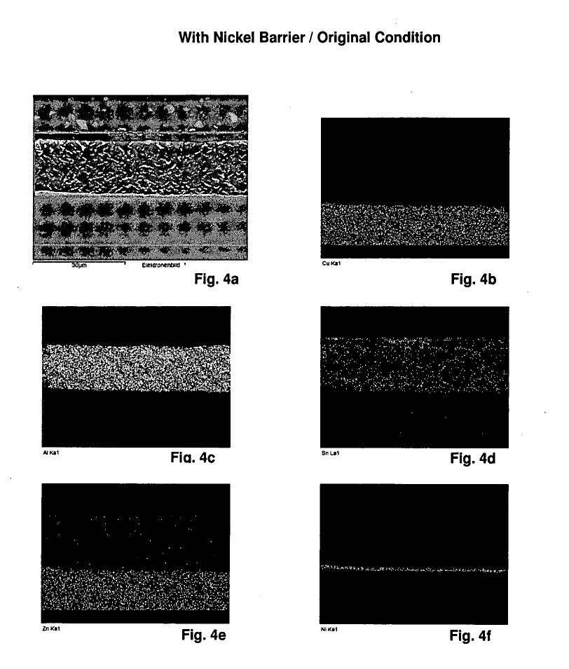

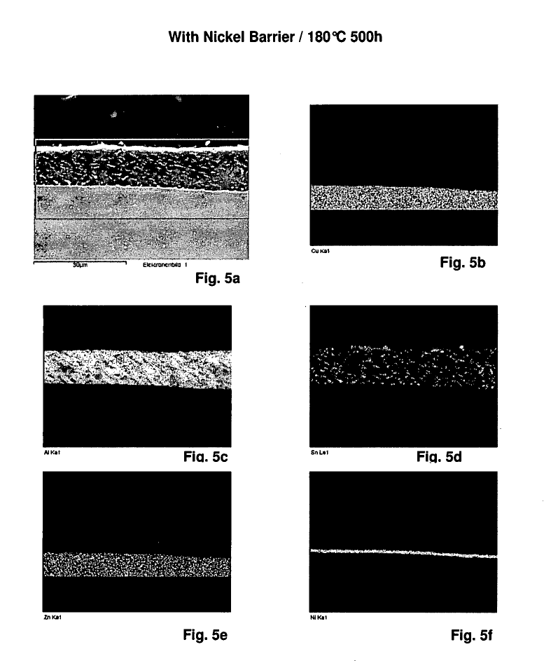

For comparison, in FIGS. 4a through 4f and 5a through 5f, a connecting rod bearing shell in which an AlSn20 overlay layer was applied by sputtering to a previously applied thick nickel barrier layer has been investigated on the basis of micrographs.

It should be noted that the disclosure is not limited to the embodiments described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A connecting rod bearing shell or bush in combustion engines, or main bearing shell, for supporting the crankshaft in combustion engines, comprising a slide bearing composite material having a metal support layer and a metal sliding layer (2) applied over the metal support layer, the sliding layer (2) being formed by a copper-zinc alloy having from 10-25 weight % Zn and 1-8 weight % Ni, and having an overlay layer (4), applied by sputtering, oriented toward the sliding layer, the overlay layer comprising an aluminum-tin alloy, characterized in that the overlay layer (4) applied by sputtering is sputtered directly onto the sliding layer (2); and that a thin nickel barrier layer (10) is thereby formed that has a thickness of less than about 1 μm.

2. The connecting rod bearing shell or bush or main bearing shell as defined by claim 1, characterized in that the nickel barrier layer (10) has a thickness of less than about 0.9 μm, in particular less than about 0.8 μm, in particular less than about 0.7 μm, in particular less than about 0.6 μm, and furthermore in particular less than about 0.5 μm.

3. The connecting rod bearing shell or bush or main bearing shell as defined by claim 1, characterized in that the nickel barrier layer (10) has a thickness of at least about 0.1 μm, in particular at least about 0.2 μm.

4. The connecting rod bearing shell or bush or main bearing shell as defined by claim 1, characterized in that the sliding layer (2) has from about 1 to about 3 weight % Mn.

5. The connecting rod bearing shell or bush or main bearing shell as defined by claim 1, characterized in that the sliding layer (2) has from about 0.5 to about 6 weight %, in particular from about 1 to about 4.5 weight % Fe.

6. The connecting rod bearing shell or bush or main bearing shell as defined by claim 1, characterized in that the sliding layer (2) has from about 2 to about 7 weight % Ni.

7. The connecting rod bearing shell or bush or main bearing shell as defined by claim 1, characterized in that the sliding layer (2) has from about 1 to about 3 weight % Al.

8. The connecting rod bearing shell or bush or main bearing shell as defined by claim 1, characterized in that the sliding layer (2) is formed by a copper-zinc alloy having from about 10 to about 25 weight % Zn, about 1 to about 3 weight % Mn, about 1 to about 8 weight % Ni, about 2 to about 6 weight % Fe, the remainder being copper, as well as contamination-caused components each amounting to a maximum of about 0.1 weight %, totaling a maximum of about 1 weight %; and that the sliding layer is crystallized solely in the a phase.

9. A connecting rod bearing shell or bush in combustion engines, or main bearing shell, for supporting the crankshaft in combustion engines, as defined by claim 1, obtainable in that the overlay layer (4) comprising an aluminum-tin alloy is applied by sputtering directly onto the sliding layer (2) without prior provision of a diffusion barrier layer.

10. A method for producing a connecting rod bearing shell or bush in combustion engines, or main bearing shell, for supporting the crankshaft in combustion engines, as defined by claim 1, characterized in that the overlay layer (4) comprising an aluminum-tin alloy is applied by sputtering directly onto the sliding layer (2) without prior provision of a diffusion barrier layer.

11. The method as defined by claim 10, characterized in that the sliding layer (2) is plasma-etched before being applied by sputtering.
